(19) United States
(12) Patent Application Publication
(10) Pub. No.: US 2013/0265490 A1
(43) Pub. Date: Oct. 10, 2013

(54) Video Analytic Encoding

(71) Applicant: Scott A. Krig, Santa Clara, CA (US)

(72) Inventor: Scott A. Krig, Santa Clara, CA (US)

(21) Appl. No.: 13/993,841

(22) PCT Filed: Nov. 14, 2011
(86) PCT No.: PCT/US11/60517

§ 371 Date: Jun. 13, 2013

(51) Int. Cl. H04N 7/088

(52) U.S. Cl. CPC H04N 7/088
USPC 348/465

(57) ABSTRACT

An encoded media file or stream may include video analytics data. There data may include information about the objects depicted in the media.

### BACKGROUND

This relates to encoding video analytics results.

Video analytics is the analysis of imaged scenes, generally from video, in order to obtain information about the objects depicted in those video scenes. Examples of video analytics include surveillance video analysis where persons or objects in the video are recognized, face and object recognition systems, and tracking systems that track objects, such as cars on highways, by analyzing the video using electronic techniques.

### BRIEF DESCRIPTION OF THE DRAWINGS

FIG. 1 is a system architecture in accordance with one embodiment of the present invention;

FIG. 2 is a circuit depiction for the video analytics engine shown in FIG. 1 in accordance with one embodiment;

FIG. 3 is a flow chart for video capture in accordance with one embodiment of the present invention;

FIG. 4 is a flow chart for a two dimensional matrix memory in accordance with one embodiment;

FIG. 5 is a flow chart for analytics assisted encoding in accordance with one embodiment;

FIG. 6 is a depiction of an indexed method of identifying media frame types;

FIG. 7 is a depiction of an interleaved method for depicting media frame types; and

FIG. 8 is a flow chart for one embodiment of the present invention.

### DETAILED DESCRIPTION

In accordance with some embodiments, the information obtained as a result of video analytics may be encoded using a repeatable coding format. As a result, video analytic information may be stored along with the encoded media file or stream. This may enable a wide variety of video analytic solutions by pre-processing the media to allow applications to focus on analysis of the objects within a scene, rather than segmenting and identifying objects in the scene. Common objects may include faces, persons, automobiles, household furniture, and appliances, to mention some examples.

Example applications include intelligent media viewers that identify and describe objects in an image scene, intelligent travel guidance systems for tourism or shopping, scene analysis systems for surveillance and security applications, automotive travel and guidance systems, immersive sporting events media with rich metadata overlays for each player on screen, enabling interactive controls for fine grained metadata for many objects.

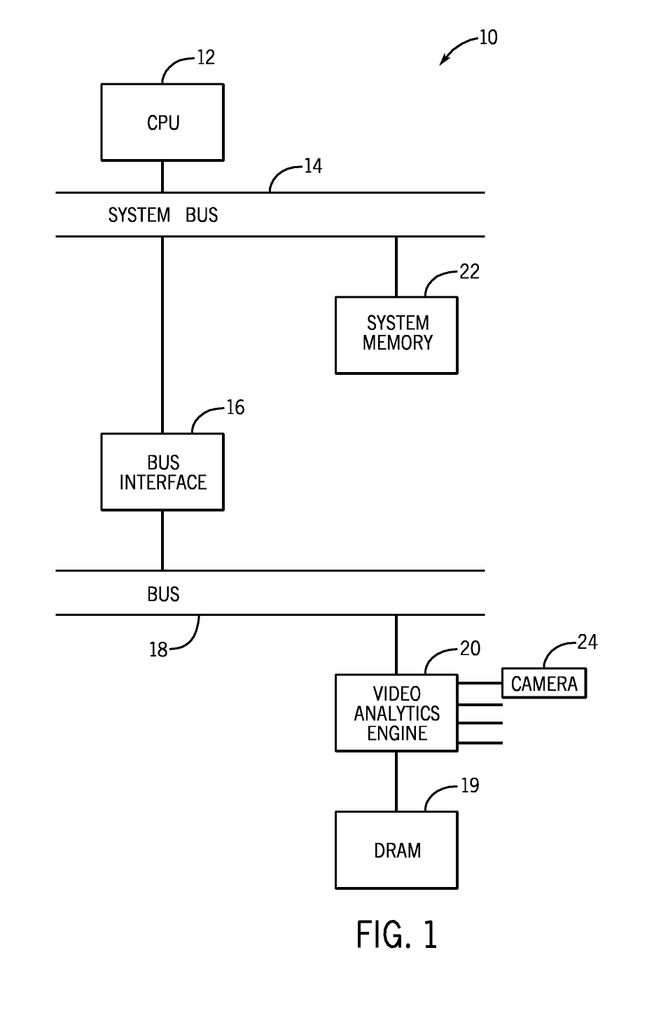

Referring to FIG. 1, a computer system 10 may be any of a variety of computer systems, including those that use video analytics, such as video surveillance and video conferencing application, as well as embodiments which do not use video analytics. The system 10 may be a desk top computer, a server, a laptop computer, a mobile Internet device, or a cellular telephone, to mention a few examples.

The system 10 may have one or more host central processing units 12, coupled to a system bus 14. A system memory 22 may be coupled to the system bus 14. While an example of a host system architecture is provided, the present invention is in no way limited to any particular system architecture.

The system bus 14 may be coupled to a bus interface 16, in turn, coupled to a conventional bus 18. In one embodiment, the Peripheral Component Interconnect Express (PCIe) bus may be used, but the present invention is in no way limited to any particular bus.

A video analytics engine 20 may be coupled to the host via a bus 18. In one embodiment, the video analytics engine may be a single integrated circuit which provides both encoding and video analytics. In one embodiment, the integrated circuit may use embedded Dynamic Random Access Memory (EDRAM) technology. In another embodiment, the video analytics engine may use an embedded processor and software or firmware. However, in some embodiments, either encoding or video analytics may be dispensed with. In addition, in some embodiments, the engine 20 may include a memory controller that controls an on-board integrated two dimensional matrix memory, as well as providing communications with an external memory.

Thus, in the embodiment illustrated in FIG. 1, the video analytics engine 20 communicates with a local dynamic random access memory (DRAM) 19. Specifically, the video analytics engine 20 may include a memory controller for accessing the memory 19. Alternatively, the engine 20 may use the system memory 22 and may include a direct connection to system memory.

Also coupled to the video analytics engine 20 may be one or more cameras 24. In some embodiments, up to four simultaneous video inputs may be received in standard definition format. In some embodiments, one high definition input may be provided on three inputs and one standard definition may be provided on the fourth input. In other embodiments, more or less high definition inputs may be provided and more or less standard definition inputs may be provided. As one example, each of three inputs may receive ten bits of high definition input data, such as R, G and B inputs or Y, U and V inputs, each on a separate ten bit input line.

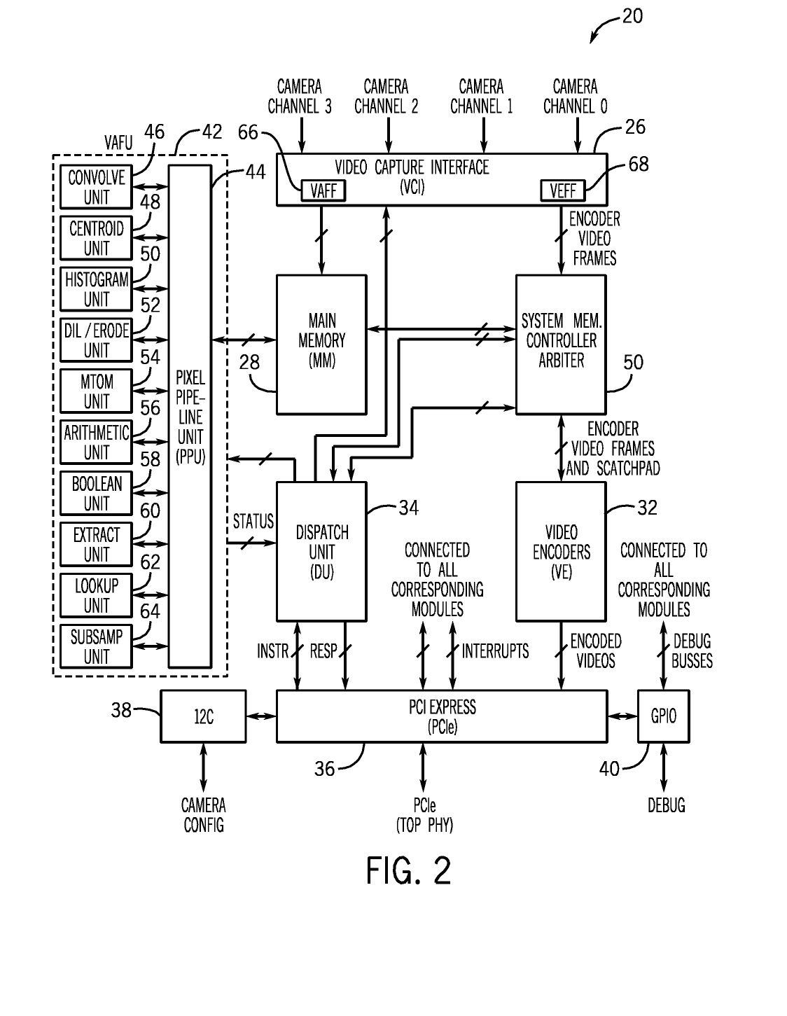

One embodiment of the video analytics engine 20, shown in FIG. 2, is depicted in an embodiment with four camera channel inputs at the top of the page. The four inputs may be received by a video capture interface 26. The video capture interface 26 may receive multiple simultaneous video inputs in the form of camera inputs or other video information, including television, digital video recorder, or media player inputs, to mention a few examples.

The video capture interface automatically captures and copies each input frame. One copy of the input frame is provided to the VAFF unit 66 and the other copy may be provided to VEFF unit 68. The VEFF unit 68 is responsible for storing the video on the external memory, such as the memory 22, shown in FIG. 1. The external memory may be coupled to an on-chip system memory controller/arbiter 50 in one embodiment. In some embodiments, the storage on the external memory may be for purposes of video encoding. Specifically, if one copy is stored on the external memory, it can be accessed by the video encoders 32 for encoding the information in a desired format. In some embodiments, a plurality of formats are available and the system may select a particular encoding format that is most desirable.

As described above, in some cases, video analytics may be utilized to improve the efficiency of the encoding process implemented by the video encoders 32. Once the frames are encoded, they may be provided via the PCI Express bus 36 to the host system.

At the same time, the other copies of the input video frames are stored on the two dimensional matrix or main memory 28. The VAFF may process and transmit all four input video channels at the same time. The VAFF may include four replicated units to process and transmit the video. The transmission of video for the memory 28 may use multiplexing. Due to the delay inherent in the video retrace time, the transfers of multiple channels can be done in real time, in some embodiments.

Storage on the main memory may be selectively implemented non-linearly or linearly. In conventional, linear addressing one or more locations on intersecting addressed lines are specified to access the memory locations. In some cases, an addressed line, such as a word or bitline, may be specified and an extent along that word or bitline may be indicated so that a portion of an addressed memory line may be successively stored in automated fashion.

In contrast, in two dimensional or non-linear addressing, both row and column lines may be accessed in one operation. The operation may specify an initial point within the memory matrix, for example, at an intersection of two addressed lines, such as row or column lines. Then a memory size or other delimiter is provided to indicate the extent of the matrix in two dimensions, for example, along row and column lines. Once the initial point is specified, the entire matrix may be automatically stored by automated incrementing of addressable locations. In other words, it is not necessary to go back to the host or other devices to determine addresses for storing subsequent portions of the memory matrix, after the initial point. The two dimensional memory offloads the task of generating addresses or substantially entirely eliminates it. As a result, in some embodiments, both required bandwidth and access time may be reduced.

Basically the same operation may be done in reverse to read a two dimensional memory matrix. Alternatively, a two dimensional memory matrix may be accessed using conventional linear addressing as well.

While an example is given wherein the size of the memory matrix is specified, other delimiters may be provided as well, including an extent in each of two dimensions (i.e. along word and bitlines). The two dimensional memory is advantageous with still and moving pictures, graphs, and other applications with data in two dimensions.

Information can be stored in the memory 28 in two dimensions or in one dimension. Conversion between one and two dimensions can occur automatically on the fly in hardware, in one embodiment.

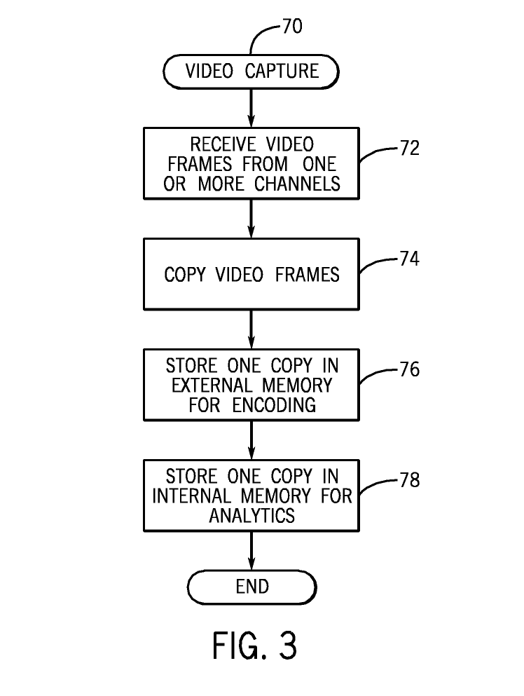

Thus, referring to FIG. 3, a system for video capture 20 may be implemented in hardware, software, and/or firmware. Hardware embodiments may be advantageous, in some cases, because they may be capable of greater speeds.

As indicated in block 72, the video frames may be received from one or more channels. Then the video frames are copied, as indicated in block 74. Next, one copy of the video frames is stored in the external memory for encoding, as indicated in block 76. The other copy is stored in the internal or the main memory 28 for analytics purposes, as indicated in block 78.

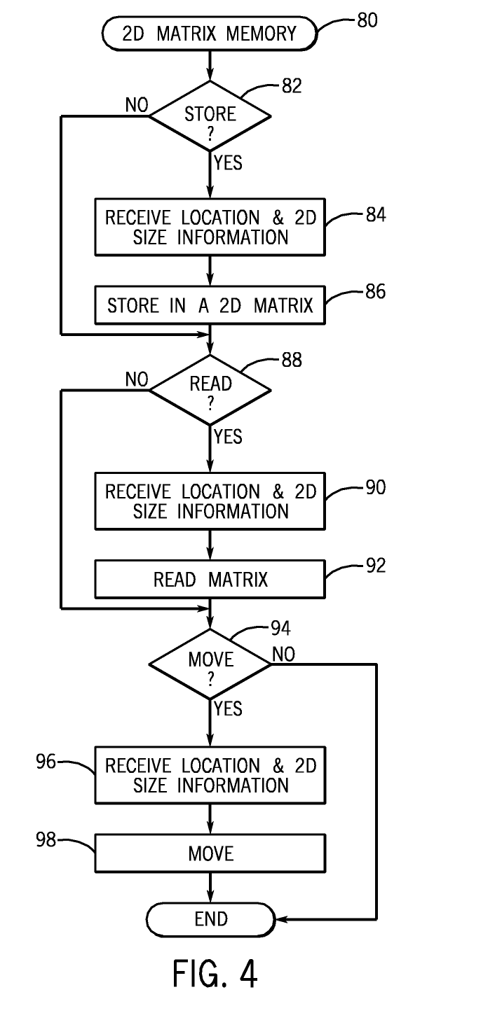

Referring next to the two dimensional matrix sequence 80, shown in FIG. 4, a sequence may be implemented in software, firmware, or hardware. Again, there may be speed advantages in using hardware embodiments.

Initially, a check at diamond 82 determines whether a store command has been received. Conventionally, such commands may be received from the host system and, particularly, from its central processing unit 12. Those commands may be received by a dispatch unit 34, which then provides the commands to the appropriate units of the engine 20, used to implement the command. When the command has been implemented, in some embodiments, the dispatch unit reports back to the host system.

If a store command is involved, as determined in diamond 82, an initial memory location and two dimensional size information may be received, as indicated in block 84. Then the information is stored in an appropriate two dimensional matrix, as indicated in block 86. The initial location may, for example, define the upper left corner of the matrix. The store operation may automatically find a matrix within the memory 20 of the needed size in order to implement the operation. Once the initial point in the memory is provided, the operation may automatically store the succeeding parts of the matrix without requiring additional address computations, in some embodiments.

Conversely, if a read access is involved, as determined in diamond 88, the initial location and two dimensional size information is received, as indicated in block 90. Then the designated matrix is read, as indicated in block 92. Again, the access may be done in automated fashion, wherein the initial point may be accessed, as would be done in conventional linear addressing, and then the rest of the addresses are automatically determined without having to go back and compute addresses in the conventional fashion.

Finally, if a move command has been received from the host, as determined in block 94, the initial location and two dimensional size information is received, as indicated in block 96, and the move command is automatically implemented, as indicated in block 98. Again, the matrix of information may be automatically moved from one location to another, simply by specifying a starting location and providing size information.

Referring back to FIG. 2, the video analytics unit 42 may be coupled to the rest of the system through a pixel pipeline unit 44. The unit 44 may include a state machine that executes commands from the dispatch unit 34. Typically, these commands originate at the host and are implemented by the dispatch unit. A variety of different analytics units may be included based on application. In one embodiment, a convolve unit 46 may be included for automated provision of convolutions.

The convolve command may include both a command and arguments specifying a mask, reference or kernel so that a feature in one captured image can be compared to a reference two dimensional image in the memory 28. The command may include a destination specifying where to store the convolve result.

In some cases, each of the video analytics units may be a hardware accelerator. By “hardware accelerator,” it is intended to refer to a hardware device that performs a function faster than software running on a central processing unit.

In one embodiment, each of the video analytics units may be a state machine that is executed by specialized hardware dedicated to the specific function of that unit. As a result, the units may execute in a relatively fast way. Moreover, only one clock cycle may be needed for each operation implemented by a video analytics unit because all that is necessary is to tell the hardware accelerator to perform the task and to provide the arguments for the task and then the sequence of operations may be implemented, without further control from any processor, including the host processor.

Other video analytics units, in some embodiments, may include a centroid unit 48 that calculates centroids in an automated fashion, a histogram unit 50 that determines histograms in automated fashion, and a dilate/erode unit 52.

The dilate/erode unit 52 may be responsible for either increasing or decreasing the resolution of a given image in automated fashion. Of course, it is not possible to increase the resolution unless the information is already available, but, in some cases, a frame received at a higher resolution may be processed at a lower resolution. As a result, the frame may be available in higher resolution and may be transformed to a higher resolution by the dilate/erode unit 52.

The Memory Transfer of Matrix (MTOM) unit 54 is responsible for implementing move instructions, as described previously. In some embodiments, an arithmetic unit 56 and a Boolean unit 58 may be provided. Even though these same units may be available in connection with a central processing unit or an already existent coprocessor, it may be advantageous to have them onboard the engine 20, since their presence on-chip may reduce the need for numerous data transfer operations from the engine 20 to the host and back. Moreover, by having them onboard the engine 20, the two dimensional or matrix main memory may be used in some embodiments.

An extract unit 60 may be provided to take vectors from an image. A lookup unit 62 may be used to lookup particular types of information to see if it is already stored. For example, the lookup unit may be used to find a histogram already stored. Finally, the subsample unit 64 is used when the image has too high a resolution for a particular task. The image may be subsampled to reduce its resolution.

In some embodiments, other components may also be provided including an I₂C interface 38 to interface with camera configuration commands and a general purpose input/output device 40 connected to all the corresponding modules to receive general inputs and outputs and for use in connection with debugging, in some embodiments.

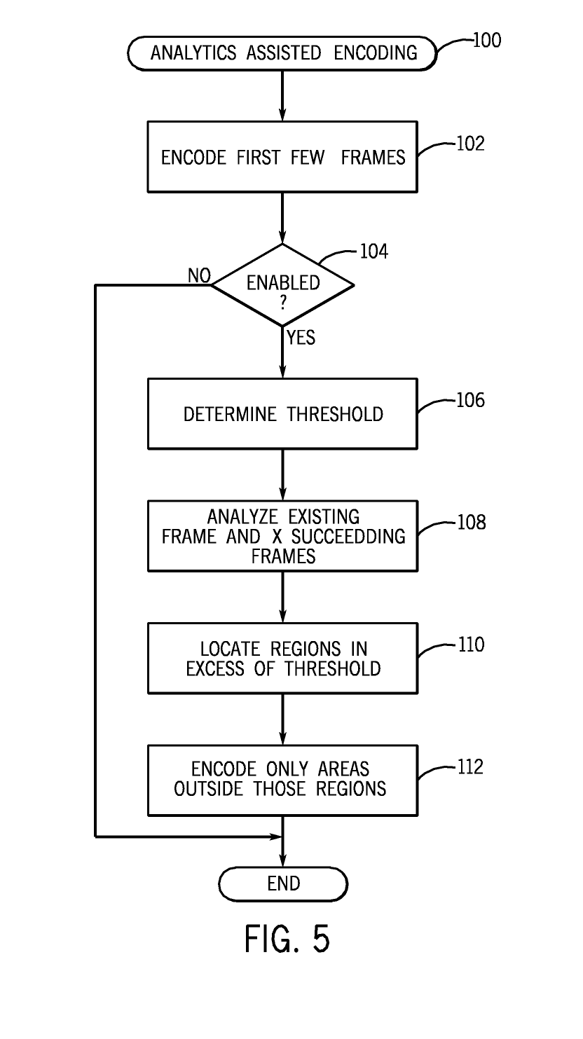

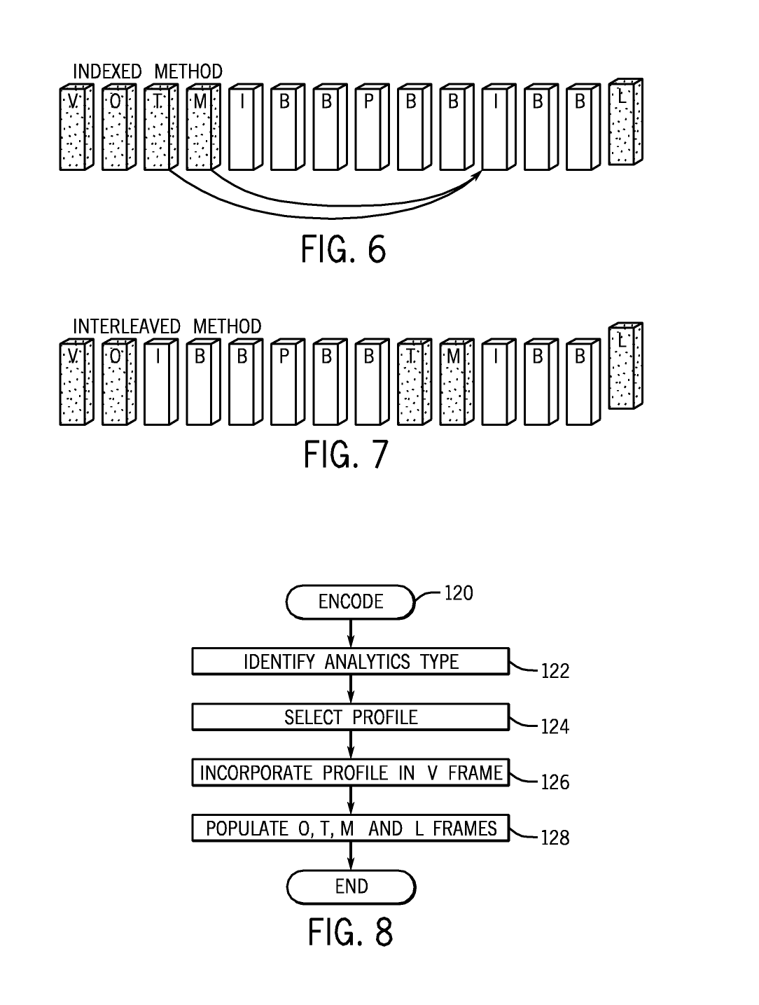

Finally, referring to FIG. 5, an analytics assisted encoding scheme 100 may be implemented, in some embodiments. The scheme may be implemented in software, firmware and/or hardware. However, hardware embodiments may be faster. The analytics assisted encoding may use analytics capabilities to determine what portions of a given frame of video information, if any, should be encoded. As a result, some portions or frames may not need to be encoded in some embodiments and, as one result, speed and bandwidth may be increased.

In some embodiments, what is or is not encoded may be case specific and may be determined on the fly, for example, based on available battery power, user selections, and available bandwidth, to mention a few examples. More particularly, image or frame analysis may be done on existing frames versus ensuing frames to determine whether or not the entire frame needs to be encoded or whether only portions of the frame need to be encoded. This analytics assisted encoding is in contrast to conventional motion estimation based encoding which merely decides whether or not to include motion vectors, but still encodes each and every frame.

In some embodiments of the present invention, successive frames are either encoded or not encoded on a selective basis and selected regions within a frame, based on the extent of motion within those regions, may or may not be encoded at all. Then, the decoding system is told how many frames were or were not encoded and can simply replicate frames as needed.

Referring to FIG. 5, a first frame or frames may be fully encoded at the beginning, as indicated in block 102, in order to determine a base or reference. Then, a check at diamond 104 determines whether analytics assisted encoding should be provided. If analytics assisted encoding will not be used, the encoding proceeds as is done conventionally.

If analytics assisted encoding is provided, as determined in diamond 104, a threshold is determined, as indicated in block 106. The threshold may be fixed or may be adaptive, depending on non-motion factors such as the available battery power, the available bandwidth, or user selections, to mention a few examples. Next, in block 108, the existing frame and succeeding frames are analyzed to determine whether motion in excess of the threshold is present and, if so, whether it can be isolated to particular regions. To this end, the various analytics units may be utilized, including, but not limited to, the convolve unit, the erode/dilate unit, the subsample unit, and the lookup unit. Particularly, the image or frame may be analyzed for motion above a threshold, analyzed relative to previous and/or subsequent frames.

Then, as indicated in block 110, regions with motion in excess of a threshold may be located. Only those regions may be encoded, in one embodiment, as indicated in block 112. In some cases, no regions on a given frame may be encoded at all and this result may simply be recorded so that the frame can be simply replicated during decoding. In general, the encoder provides information in a header or other location about what frames were encoded and whether frames have only portions that are encoded. The address of the encoded portion may be provided in the form of an initial point and a matrix size in some embodiments.

FIGS. 3, 4, and 5 are flow charts which may be implemented in hardware. They may also be implemented in software or firmware, in which case they may be embodied on a non-transitory computer readable medium, such as an optical, magnetic, or semiconductor memory. The non-transitory medium stores instructions for execution by a processor. Examples of such a processor or controller may include the analytics engine 20 and suitable non-transitory media may include the main memory 28 and the external memory 22, as two examples.

Coder/decoder (CODEC) formats include a set of encoded image frames such as I-frames, P-frames, B-frames. The main goal of encoding is to compress the media and only encode the parts of the media that change from frame to frame. Media is encoded and stored in files or sent across a network, and decoded for rendering at a display device.

The video analytic information is embodied in several meta-frames such as:

V-schema: Rules to select video analytic metrics and how to encode them.

O-frames: Objects found within a scene plus their object descriptors.

T-frames: Object tracking delta's between frames.

M-frames: Object metadata, such as a person's name, location (address, GPS coordinates), etc.

L-frames: Summary information log about all objects which have been identified and tracked in the media (optional item at end of encoded stream, text log format).

The V-frame defines which metrics should be encoded. The V-frame may be used at video encode time to determine which frames to use, such as the O-frame, T-frame, M-frame, or L-frames, and the contents of these specific frames. Thus, the V-frame scheme enables various encoding profiles that determine what information is included in the encoding format so that there may be different profiles for different objects, such as general, faces, human form, automotive, etc.

The V-frame may specify any attributes of an O-frame, T-frame, M-frame or L-frame. In other words, the V-frame scheme identifies what is possible to include in a frame and what is to be expected in the encoded media stream.

Since the V-frame scheme defines separate profiles for metrics depending upon the desired level of detail, new metrics may be added into the encoding format to create additional profiles and to define additional metrics for specific types of frames, such as O-frames, L-frames, etc.

In one embodiment, the O-frames may include various object metrics, such as a reference number for identifying the frame, together with descriptive text about what the scene depicts. Also, the O-frames may include object identifiers for each object found in the scene. Any object descriptors may be provided for features of objects within the frame, such as the pixel area, perimeter, centroid, longest and shortest axes passing through the centroid to the perimeter, bounding box, polygon outline, Fourier descriptor, average color, number of morphological holes, color spectrum, histogram of gray values, histogram of color intensity, texture metrics, and directional edge metrics, to give some examples.

Compound object associations may also be included in the O-frames in the form of a list of objects that may be associated together in a compound object, such as in a road scene, which may include cars, road, and signs or a depicted face, which may include an eye, nose, cheek, chin, ear, etc., using their respective object identifiers. In the case of a facial depiction, facial feature location points in either two or three dimensions may be provided for eyes, nose, cheek, chin, ears, crown of head, etc. that may be stored as an array of two or three dimensional points. The O-frames may also include object feature location points within the image frame for things like cars, furniture, humans, appliances, plants, animals, etc. Two dimensional mesh descriptors of objects may identify faces, people, cars, and the like. The same may be done with three dimensional mesh descriptors.

Background and foreground segmentation may be provided in the O-frames for objects to determine which objects are background and are not of interest and which objects are foreground and are of interest.

The T-frames may be used to track or record the movement of objects between frames. Specifically, the T-frames may be used to track the motion of objects that have been previously encoded in O-frames. For example, an O-frame may encode a face descriptor by a given object and a subsequent T-frame may record the tracking and movement of the face object within the scene.

In some embodiments, a tracking mechanism may include a reference frame, which is an O-frame identifier referenced by the T-frame, and an object identifier, which is the object identifier that is tracked. Multiple object identifiers are possible within a T-frame. Then, for each tracked object identifier in one embodiment, a confidence factor, tracking metric, and a track count may be provided. The confidence factor may indicate how accurate the identification of the object is believed to be using a floating point number (0 . . . 1.0 for example)or a text string (high medium or low for example). The tracked metric may indicate that if an object is present in the current frame, the T-frame records the metric tracked, such as a centroid or other unique metric, or a combination of several metrics used together for tracking purposes to increase confidence. The track count may include a cumulative count of contiguous frames containing the object, or a list of frame sequence numbers of frames containing the object.

The M-frames may include metadata about the scene or objects in the scene. For example, a sporting event media M-frame may include metadata about each athlete's statistics, name, teams, height, weight, scoring details, etc. For example, an M-frame metadata may include personal or professional data, global positioning system (GPS) coordinates for each frame, addresses, compass angle of the camera, time of day and date, elevation and temperature, the name of each object or person, and other information as defined in the V-scheme.

The L-frames are log frames and may be located anywhere within the encoded video stream. However, typically, they may be placed at the end of each file or stream. The L-frames contain a summary log about objects tracked and may include information like the elapsed time of each viewed object, number of frames where the object is visible, and a relative motion detector for each tracked object within the frame. The L-frame may contain useful information in particular contexts. In a security and surveillance application, the L-frame may include information about how long a person has been loitering in a given area and if the person is a repeat offender.

Thus, referring to FIG. 8, in accordance with one embodiment, an encode sequence 120 may be implemented in software, firmware, and/or hardware. In software and firmware embodiments, the sequence 120 may be implemented using computer executed instructions stored in a non-transitory computer readable medium, such as a magnetic, optical, or semiconductor storage device.

The sequence begins by identifying an analytics type, as indicated in block 122. For example, facial analysis may be one type and an analysis of cars on the highway for managing traffic may be another type. Then, a specific profile for the V-scheme may be selected, as indicated in block 24. The profile is then incorporated into the V-frame, as indicated in block 26. Finally, the O, T, M, and L-frames are populated, as indicated in block 128, as specified by the V-frame.

The graphics processing techniques described herein may be implemented in various hardware architectures. For example, graphics functionality may be integrated within a chipset. Alternatively, a discrete graphics processor may be used. As still another embodiment, the graphics functions may be implemented using software or firmware by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
storing information about video analytics of media in association with the encoded media.

2. The method of claim 1 including providing a frame to indicate what type of video analytics information is included with the encoded media.

3. The method of claim 2 including providing a plurality of selectable analytics types for encoding.

4. The method of claim 1 including providing a frame to identify objects within the encoded media.

5. The method of claim 4 wherein providing a frame to identify objects includes identifying a frame of encoded media, identifying objects in said encoded media frame, and providing descriptors that give information about identified objects.

6. The method of claim 1 including providing a frame to indicate the movement of objects being tracked in the media.

7. The method of claim 6 including providing a confidence indicator to indicate how certain is an identification of an object in the media.

8. The method of claim 6 wherein providing a frame to indicate movement including indicating a frame of encoded media, identifying an object by an identifier, indicating a tracked metric and a count of frames in which an object is depicted.

9. The method of claim 1 including providing a frame for metadata about objects depicted in the media.

10. The method of claim 9 wherein providing a frame for metadata includes providing metadata to enable a user to find more information about an object depicted in an encoded frame while viewing the encoded frame.

11. The method of claim 1 including providing a frame with analytics summary information.

12. A non-transitory computer readable medium storing instructions that enable a computer to:
store data about video analytics of media in association with the encoded media.

13. The medium of claim 12 further storing instructions to provide a frame to indicate what type of video analytics information is included with the encoded media.

14. The medium of claim 13 further storing instructions to provide a plurality of selectable analytics types for encoding.

15. The medium of claim 12 further storing instructions to provide a frame within the analytics information to identify objects within the encoded media.

16. The medium of claim 12 further storing instructions to provide a frame with encoded media to indicate the movement of objects being tracked in the media.

17. The medium of claim 12 further storing instructions to provide a frame in the information about the video analytics for metadata about objects depicted in the media.

18. The medium of claim 12 further storing instructions to provide a summary of the analytics information stored in association with the encoded media.

19. The medium of claim 16 further storing instructions to provide a confidence indicator to indicate how certain is an identification of an object in the media.

20. An encoder comprising:
a processor to store encoded media, together with video analytics information for that encoded media; and
a memory coupled to said processor.

21. The encoder of claim 20, said processor to provide video analytics information indicating what type of video analytics information is included in the encoded media.

22. The encoder of claim 21, said processor to provide a plurality of selectable analytics types for encoding.

23. The encoder of claim 20, said processor to provide a frame to identify objects within the encoded media.

24. The encoder of claim 20, said processor to provide a frame to indicate the movement of objects being tracked in the media.

25. The encoder of claim 24, said processor to provide a confidence indicator indicating how certain is an identification of an object in the media.

26. The encoder of claim 20, said processor to provide a frame for metadata about objects depicted in the media.

27. The encoder of claim 20, said processor to provide a frame with analytics summary information.

28. The encoder of claim 20, said processor to provide a frame indicating what type of video analytics information is included with the encoded media, a frame identifying objects within the encoded media, a frame indicating the movement of objects being tracked in the media, a frame for metadata about objects depicted in the media, and a frame with analytics summary information for each of said analytics frames.
